(19) United States
(12) Patent Application Publication
(10) Pub. No.: US 2017/0161008 A1
(43) Pub. Date: Jun. 8, 2017

(54) MULTI DISPLAY DEVICE

(71) Applicant: MODERN C&C CO.,LTD, Busan (KR)

(72) Inventor: Taepyeong LEE, Busan (KR)

(21) Appl. No.: 14/958,323

(22) Filed: Dec. 3, 2015

(51) Int. Cl. G06F 3/14

(52) U.S. Cl. CPC G06F 3/1446

(57) ABSTRACT

The present invention relates to a multi display device increasing operational efficiency and enabling immediate response while avoiding interference with main tasks, which is characterized in that it comprises: a secondary monitor that is removably coupled with the aforesaid monitor and displays image signal input from computer; and a terminal interconnecting the output image of the aforesaid monitor and that of the secondary monitor by extending the image signal input from the aforesaid computer, while of which input terminal is connected at least one of graphic terminal, USB terminal and earphone terminal of the aforesaid computer, and of which output terminal is connected to the secondary monitor.

### TECHNICAL FIELD

The present invention relates to a multi display device increasing operational efficiency and enabling immediate response while avoiding interference with the main tasks.

### BACKGROUND ART

In general, display device of laptop and desktop computer is installed on a side of the body, being equipped with a monitor displaying data on the screen by the operation of computer.

Monitor device includes a monitor body implementing image and a base that is seated on the mounting surface such as table to support the monitor body. In this case, the monitor device includes all image implementing devices such as display devices for TV or computer. The monitor body is mainly made of a thin display panel such as LCD (Liquid Crystal Display) or PDP (Plasma Display Panel).

However, when users do multiple tasks on a single monitor, they have experienced inconvenience in grasping information due to the limitation of monitor size while popping up multiple windows on the screen at the same time.

Thus, Korean registered utility model No. 20-0316611 was disclosed to extend the action area of the computer program running on a single computer system.

FIG. 1 is a schematic diagram displaying a monitor hinged with a secondary monitor according to the prior art.

Referring to FIG. 1, the monitor equipped with a secondary monitor according to the prior art is configured so that the secondary monitor is removably inserted in the receiving grooves formed on both sides of the monitor.

However, because the aforesaid secondary monitor is fixed on the monitor, there is a problem that it is impossible to install the existing monitor.

In other words, it may cause an additional burden because it is necessary to purchase a separate monitor equipped with the aforesaid secondary monitor separately.

In addition, since the position of the aforesaid secondary monitor is limited on the side of the monitor, this position is difficult to change.

### PRIOR ART DOCUMENTS

### Patent Documents

(Patent Document 1) KR20-0316611 Y1

(Patent Document 1) KR20-0208003 Y1

(Patent Document 1) KR20-0197840 Y1

### SUMMARY OF INVENTION

### Technical Problem

The present invention aims to resolve the problems derived from the previous background art and to provide a portable multi display device that is high in utilization and detachable from the monitor.

In addition, the present invention is intended to provide a multi display device that can be installed on the existing monitor to reduce economic burden.

The purpose of the present invention also includes providing a multi display device of which the position of the secondary monitor can be freely changed by user.

The present invention will not be limited to the embodiments set forth herein but may be embodied in many different forms. Rather, the embodiments introduced here are provided to make this disclosure thorough and complete and to transmit the concept of this invention to those skilled in the art.

### Solution to Problem

The above purposes, according to an embodiment of the invention, can be achieved by multi display device that is characterized in that it comprises: a secondary monitor that is removably coupled to the aforesaid monitor and displays the image signal input from computer; and a terminal interconnecting the output image of the aforesaid monitor and that of the secondary monitor by extending the image signal input from the aforesaid computer, while of which input terminal is connected at least one of graphic terminal, USB terminal and earphone terminal of the aforesaid computer, and of which output terminal is connected to the secondary monitor.

Preferably, the aforesaid monitor is removably mounted on one side of the monitor and the support with fixing member is coupled to the other side.

Preferably, one side of the aforesaid support is bent, hinge axis is formed on the end of bent portion, and the secondary monitor is rotatably coupled around the aforesaid hinge axis.

Preferably, mirror member is removably inserted into the receiving grooves formed on the side of the secondary monitor.

Preferably, guide bar is formed on the side wall of the receiving grooves in the longitudinal direction and the aforesaid mirror member contains guide grooves that have been formed along the guide bar.

### Beneficial Effects

As described above, the multi display device of the present invention is expected to give the following effects:

First, the multi display device is portable and high in utilization since it is detachable form the monitor.

Second, the multi display device can reduce economic burden because it can be mounted on the existing monitor and it is not necessary to purchase a separate monitor.

Third, users can freely change the position of the secondary monitor.

### BRIEF DESCRIPTION OF DRAWINGS

FIG. 1 is a schematic diagram illustrating monitor hinged with secondary monitor according to the prior art.

FIG. 2 is a schematic diagram illustrating connection between multi display device and computer according to the present invention.

FIG. 3 is a diagram illustrating connection and separation between multi display device and computer monitor according to the present invention.

FIG. 4 is an exploded perspective view of multi display device according to the present invention.

FIG. 5 is a diagram explaining a rotational state of secondary monitor.

FIG. 6 is a schematic diagram illustrating connection between secondary monitor and mirror member.

FIG. 7 is an exploded perspective view of secondary monitor and mirror member.

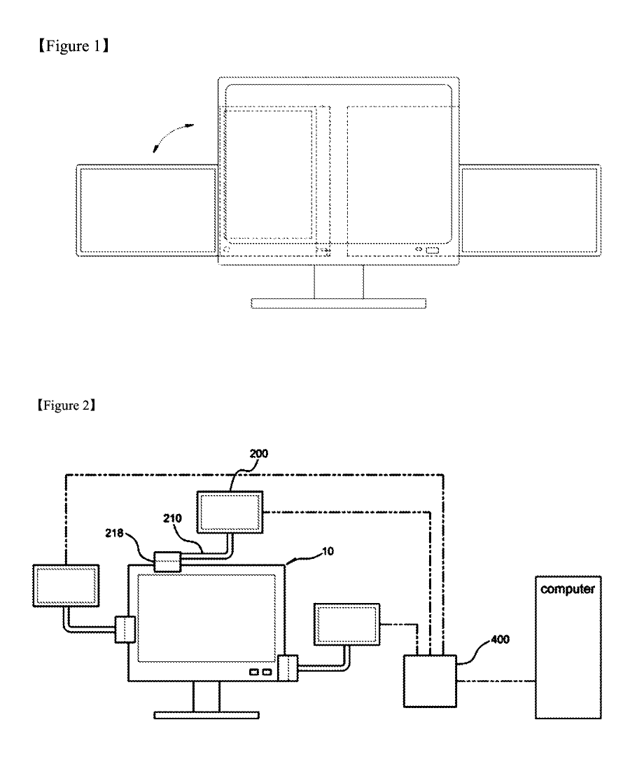

### BEST MODE FOR CARRYING OUT THE INVENTION

The benefits and characteristics of the present invention and the methods of implementation will be clarified with reference to the embodiments to be described below in detail along with attached drawings. The present invention, however, is not limited to the embodiments set forth herein but will be embodied in many different forms. Rather, these embodiments are provided to complete the disclosure of the present invention and to fully convey the concept of the present invention to those of ordinary skill in the art related to the present invention. And the terms used herein serve to explain the embodiments and are not intended to limit the present invention. In this specification the singular includes the plural unless otherwise specified.

With reference to the accompanying drawings, the present invention will be described in more detail below. On the other hand, illustration and description of the configuration that can be easily understood by those of ordinary skill in the art as well as of operation and effects thereof will be omitted or briefed, while the parts related to the present invention will be described in detail.

Multi display device according to an embodiment of the present invention relates to a multi display device, as shown in FIG. 2, for extending the monitor (10) image of computer, in a structure containing secondary monitor (200) and terminal (400).

First, secondary monitor (200) is removably coupled to the aforesaid monitor (10) and displays image the signal input from the computer.

In addition, multi display device includes a terminal (400) interconnecting the output image of the aforesaid monitor (10) and that of the aforesaid secondary monitor (200) after extending image signal input from the aforesaid computer while of which input terminal is connected to at least one of graphic terminal, USB terminal, and earphone terminal of the aforesaid computer and of which output terminal is connected to the secondary monitor (200).

Therefore, it is possible to immediately verify the programs that are often used for the tasks such as messenger, calendar, and stock trading window, without interfering with windows used for main tasks.

In this case, since the output terminal of the terminal (400) can be connected to at least one secondary monitor (200), it has the advantage to run a number of programs.

In addition, one side is bent and the other side is provided with support (210) formed with fixing member (218).

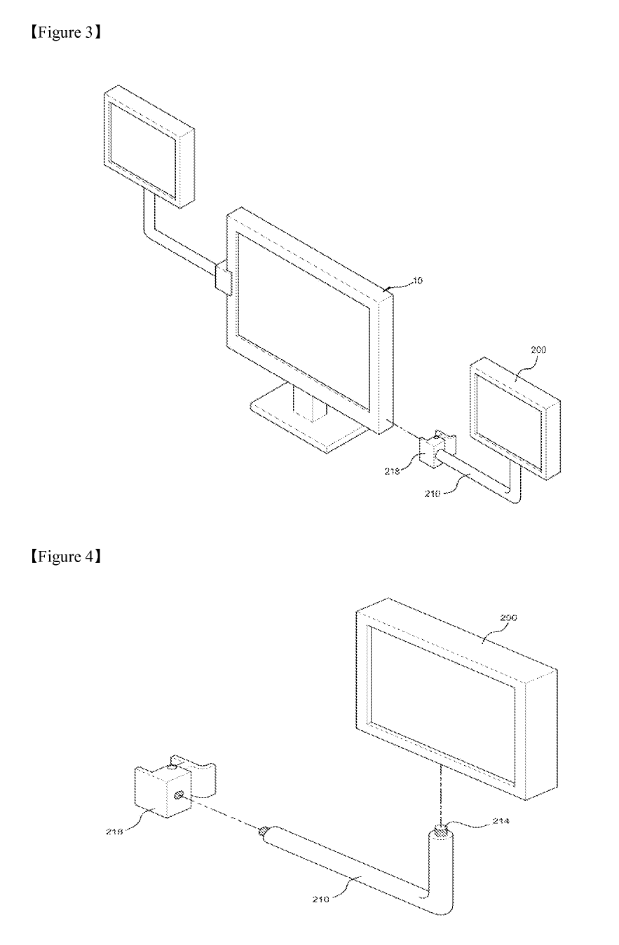

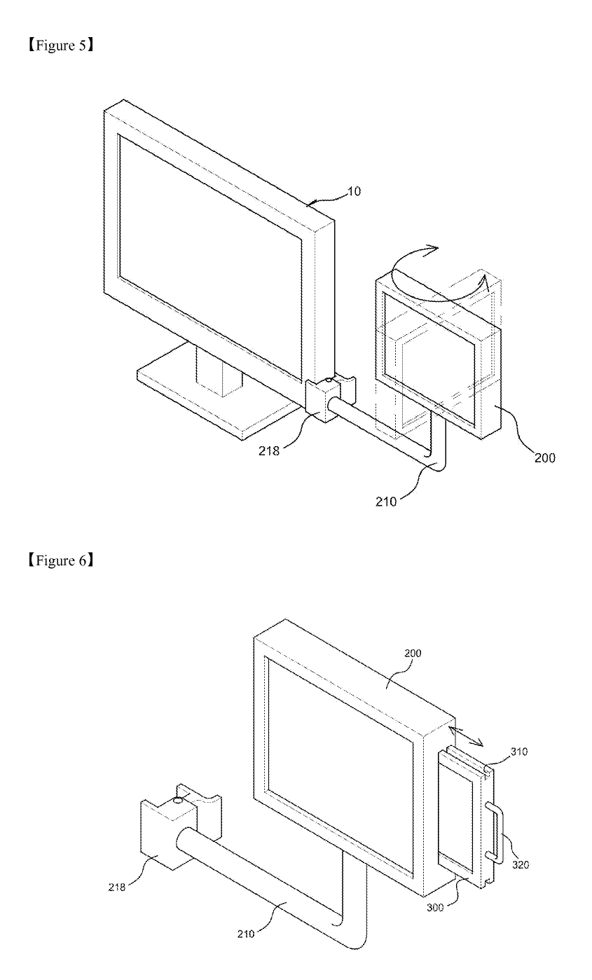

Here, as shown in FIGS. 4 and 5, hinge axis (214) is formed on the aforesaid bent end, and the secondary monitor (200) is 360° rotatably coupled around the hinge axis (214).

Accordingly, the aforesaid secondary monitor (200) can be used after adjusting the angle according to the user environment.

Furthermore, locking projections are formed on the bent end of the support (210), although not shown in the figures, during the actual product design so that the secondary monitor (200) is fixed after angle adjustment.

Further, as shown in FIG. 3, the aforesaid fixing member (218) is formed in a shape of forceps so that the secondary monitor (200) is removably coupled to the monitor (10).

In this case, the aforesaid fixing member (218) is of course available in various shapes according to intended application as well as the shape of forceps.

Thus, it is possible to install one or more secondary monitors (200) in the position of monitor (10) desired by user and to easily separate them from monitor (10) for storage.

In this case, after extension of multiple display and positioning of secondary monitor (200) in the control panel, the output image of monitor (10) and that of secondary monitor (200) are interconnected for use.

That is, regardless of positions in the monitor (10) to which the aforesaid secondary monitor (200) is coupled, it is possible to extend and output the image signal received from the aforesaid computer.

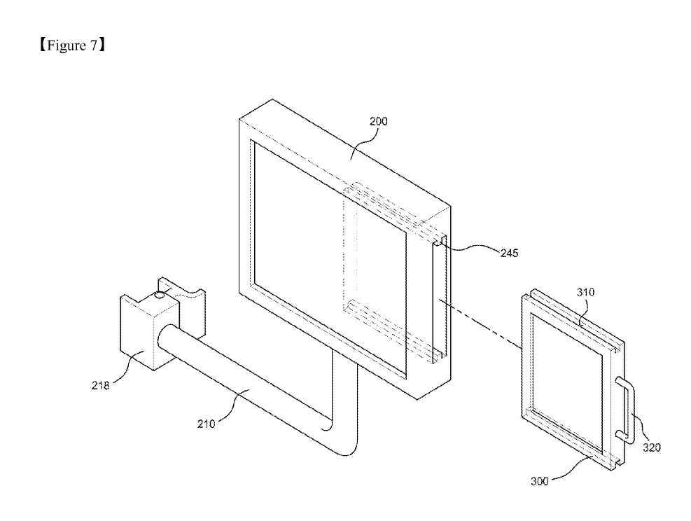

In addition, as shown in FIGS. 6 and 7, receiving groove (240) is formed on the side of the secondary monitor (200), and minor member (300) is removably inserted into the aforesaid receiving groove (240).

In this case, a guide bar (245) is formed in the longitudinal direction on the side wall of the receiving groove (240), and guide groove (310) is formed on the mirror member (300) along the guide bar (245).

Moreover, the minor member (300) can be easily pulled out by using a handle (320) formed on one side of the minor member (300).

In other words, it is possible to immediately use the mirror as well as reduce the time to prepare a hand mirror.

In addition, the secondary monitor (200) can be equipped with memo holder, business card holder, and pen holder for various utilization.

Also, design elements can be added to the secondary monitor (200) for characterization of appearance so that consumers have expanded choices for the secondary monitor (200) as well as the production for advertising and promotion.

The use of the multi display device according to the present invention can be described as follows:

First, the secondary monitor (200) shall be coupled to the monitor (10) by using the fixing member (218).

In this case, user shall determine the position and number of the secondary monitor (200) according to user environment.

Next, computer shall be connected to the terminal (400) for transmission of the image signal of monitor (10), and the terminal (400) shall be connected to the secondary monitor (200) for extension and output of transmitted image signal.

In addition, since the secondary monitor (200) is 360° rotatable, users facing the monitor (10) as well as users in an arbitrary direction can easily grasp the information on the monitor (10).

According to the embodiment of the present invention described so far, it is possible to expect the following effects:

First, the multi display device is portable and high in utilization since it is removable from the monitor.

Second, since the multi display device can be mounted on the existing monitor, users can reduce economic burden because it is not necessary to purchase a separate monitor.

Third, users can freely change the position of the secondary monitor.

The features and technical advantages of the present invention have been described above for a better understanding of claims of the invention which will be described later. It will be understood that the technical configuration of the invention described above may be embodied in specific forms by those skilled in the art of the present invention without changing the technical idea or essential features of the present invention. Therefore, it should be understood that the embodiments described above are intended to be illustrative in all respects to be understood as non-limiting, that the scope of the present invention appears in the claims below rather than by the description above, and that the spirit and scope of the claims and all the changes or modified forms deriving from its equivalents fall within the scope of the present invention.

### DESCRIPTION OF SIGNS

Monitor: 10

Secondary monitor: 200

Support: 210

Hinge axis: 214

Fixing member: 218

Receiving groove: 240

Guide bar: 245

Mirror member: 300

Guide groove: 310

Handle: 320

Terminal: 400

1. With respect to the multi display device for extending the monitor image of computer,
the multi display device is characterized in that it comprises:
a secondary monitor that is removably coupled with the aforesaid monitor and displays image signal input from computer; and
a terminal interconnecting the output image of the aforesaid monitor and that of the secondary monitor by extending the image signal input from the aforesaid computer, while of which input terminal is connected at least one of graphic terminal, USB terminal and earphone terminal of the aforesaid computer, and of which output terminal is connected to the secondary monitor.

2. With respect to claim 1,
the multi display device is characterized in that:
the aforesaid secondary monitor is coupled to one side of the multi display device, and
the aforesaid secondary monitor provided with support with fixing member is coupled to the other side.

3. With respect to claim 2,
the multi display device is characterized in that:
one side of the aforesaid support is bent, while hinge axis is formed on the end of the bent portion, and
the secondary monitor is rotatably coupled around the aforesaid hinge axis.

4. With respect to claim 1,
the multi display device is characterized in that the mirror member is removably inserted into the receiving grooves formed on the side of the secondary monitor.

5. With respect to claim 4,
the multi display device is characterized in that:
a guide bar is formed on the side wall of the receiving grooves in the longitudinal direction; and
guide grooves to slide along the aforesaid guide bar to be coupled thereto is formed on the aforesaid minor member.
